(19) United States
(12) Patent Application Publication
(10) Pub. No.: US 2007/0114969 A1
(43) Pub. Date: May 24, 2007

(54) MAGNETIC ELECTRICAL DAISY CONNECTION FOR SIMULTANEOUSLY RECHARGING ELECTRONIC DEVICES

(75) Inventor: George Marmaropoulos, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 11/419,791

(22) Filed: May 23, 2006

Related U.S. Application Data
(60) Provisional application No. 60/738,836, filed on Nov. 22, 2005.

(51) Int. Cl. H02J 7/00

(52) U.S. Cl. 320/108

(57) ABSTRACT

A rechargeable electronic device (20, 80) employs a magnetic rechargee interface (30, 90), and a magnetic rechargor interface (40, 100) in electrical communication with the magnetic recharges interface (30, 90). In operation, the magnetic rechargee interface (30, 90) and the magnetic rechargor interface (40, 100) simultaneously recharge the rechargeable electronic device (20, 80) and one or more additional rechargeable electronic device (20, 80) based on the magnetic rechargee interface (30, 90) being magnetically coupled to a battery charger (50, 110) and based on the magnetic rechargor interface (40, 100) being magnetically coupled to the additional rechargeable electronic device(s) (20, 80).

This application claims the benefit of U.S. Provisional Application Ser. No. 60/738,836 filed on Nov. 22, 2005, the entirety of which is hereby incorporated by reference.

The present invention generally relates to a simultaneous recharging of rechargeable electronic devices of any type. The present invention specifically relates to a magnetic daisy connection for simultaneously recharging multiple LED candle units.

In some applications of rechargeable electronic devices, there is a need to regularly recharge a number of these units in a simultaneous manner. A number of known solutions can be applied to implement the simultaneous recharging of a number of rechargeable electronic devices. However, these known solutions have undesirable drawbacks. For example, a cable recharging solution is normally inexpensive, but requires a number of individual cables and connectors which can require extensive storage, can be lost easily and can require considerable time for connection. Also by example, an inductive (wireless) recharging solution is a more operationally convenient solution in view of the absence of any cables but can be expensive and requires a recharging base which is not convenient to carry around especially when the recharging base is made to accommodate a large number of units.

The present invention provides a new and unique magnetic based interfaces for simultaneously recharging a plurality of rechargeable electronic devices in a manner that overcomes the drawbacks of the known recharging solutions.

In one form of the present invention, a rechargeable electronic device comprises a magnetic rechargee interface and a magnetic rechargor interface in electrical communication with the magnetic rechargee interface. The magnetic recharge interface and the magnetic rechargor interface are operable to simultaneously recharge the rechargeable electronic device and one or more additional rechargeable electronic devices based on the magnetic rechargee interface being magnetically coupled to a battery charger and based on the magnetic rechargor interface being magnetically coupled to the additional rechargeable electronic device(s).

The foregoing form and other forms of the present invention as well as various features and advantages of the present invention will become further apparent from the following detailed description of various embodiments of the present invention read in conjunction with the accompanying drawings. The detailed description and drawings are merely illustrative of the present invention rather than limiting, the scope of the present invention being defined by the appended claims and equivalents thereof.

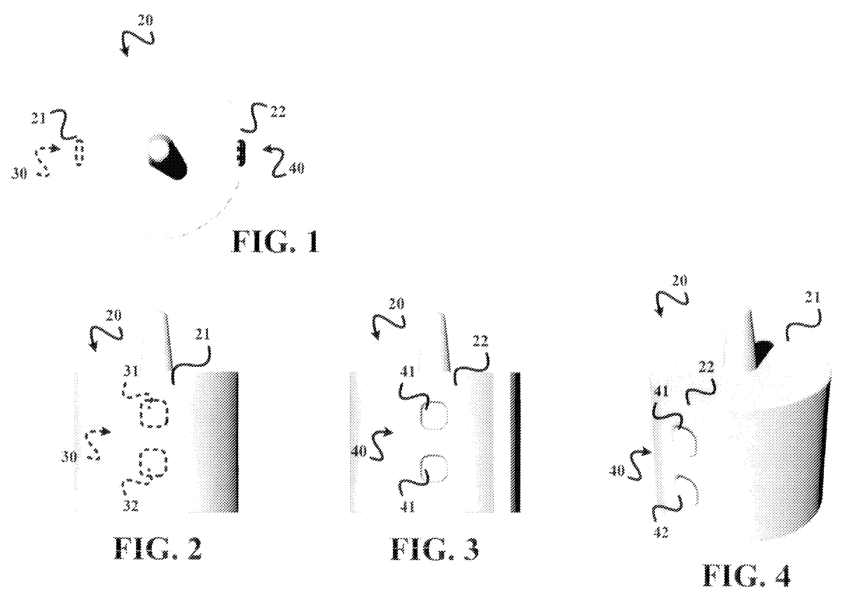

FIGS. 1-4 illustrates a top view, a pair of side views and a perspective view, respectively, of one embodiment of a rechargeable LED candle unit in accordance with the present invention;

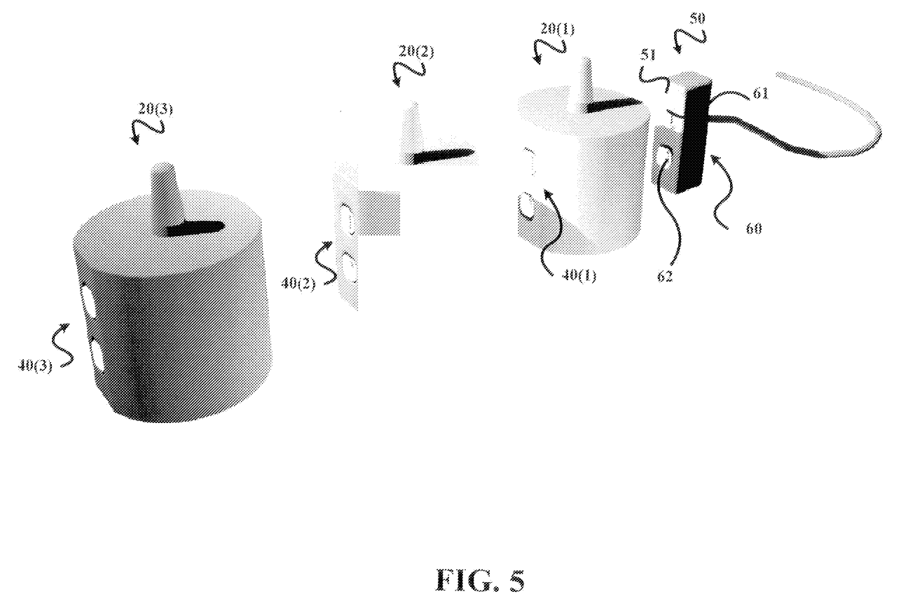

FIG. 5 illustrates a perspective view of a pre-magnetic daisy connection of a trio of rechargeable LED candle units as illustrated in FIGS. 1-4 to a battery charger in accordance with the present invention;

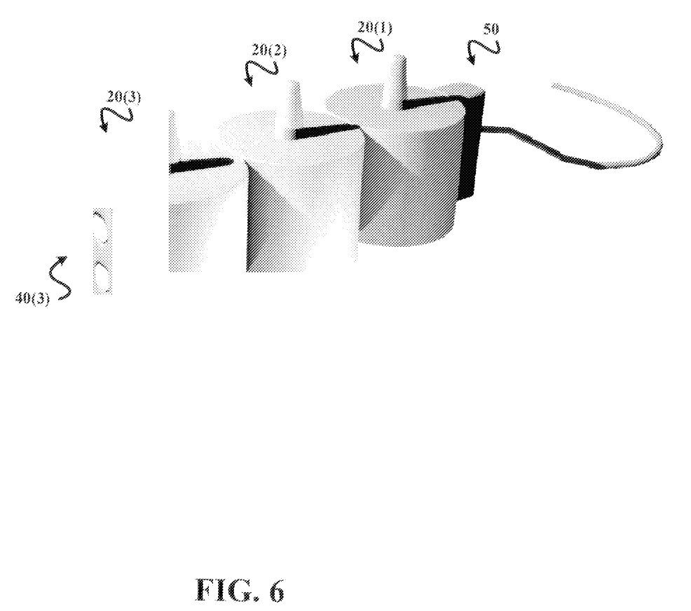

FIG. 6 illustrates a perspective view of a magnetic daisy connection of a trio of rechargeable LED candle units as illustrated in FIGS. 1-4 to a battery charger in accordance with the present invention;

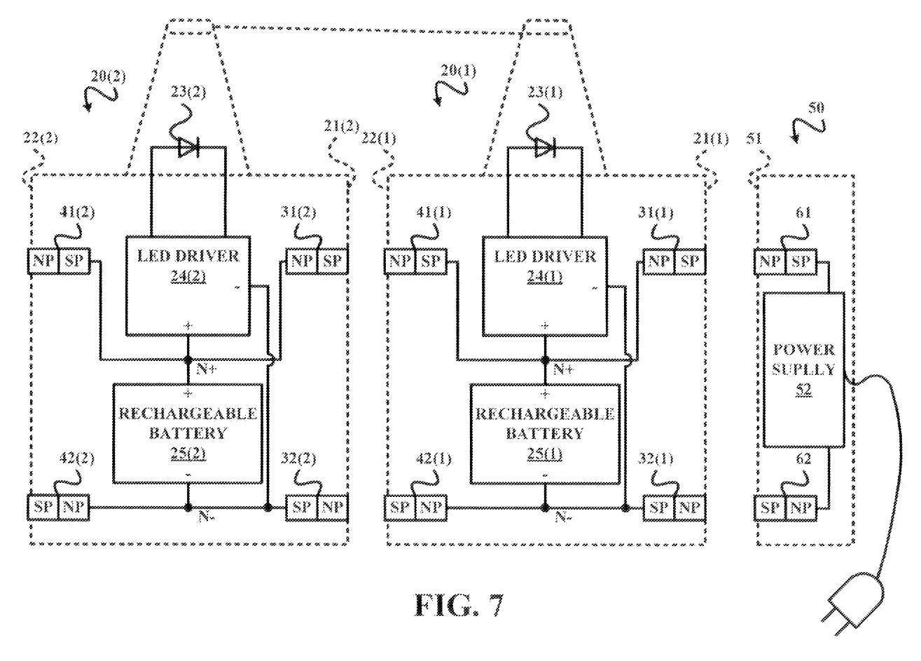

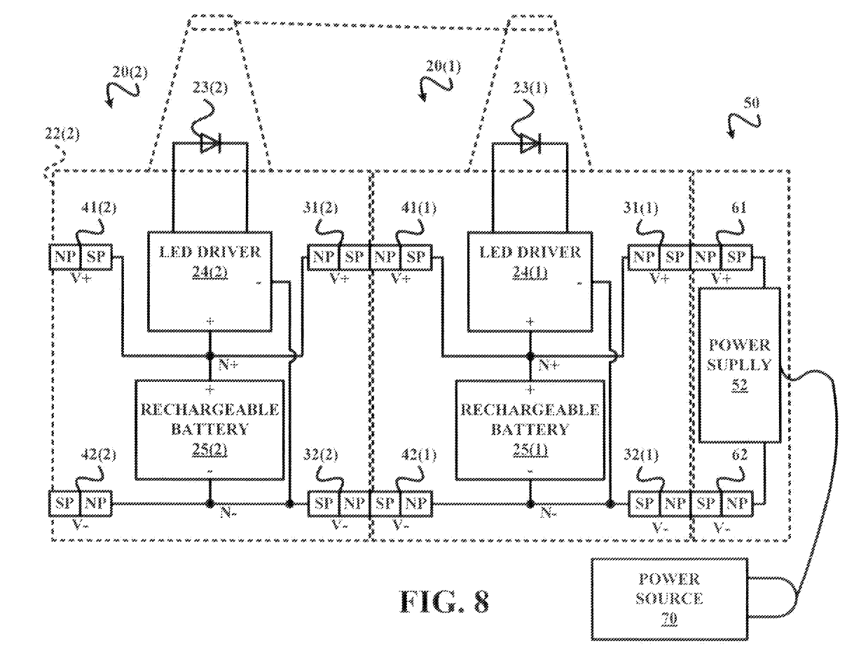

FIGS. 7 and 8 illustrate a schematic diagram of a pair of rechargeable LED candle units as illustrated in FIGS. 1-6 and of the battery charger illustrated in FIGS. 5-6 in accordance with the present invention; and

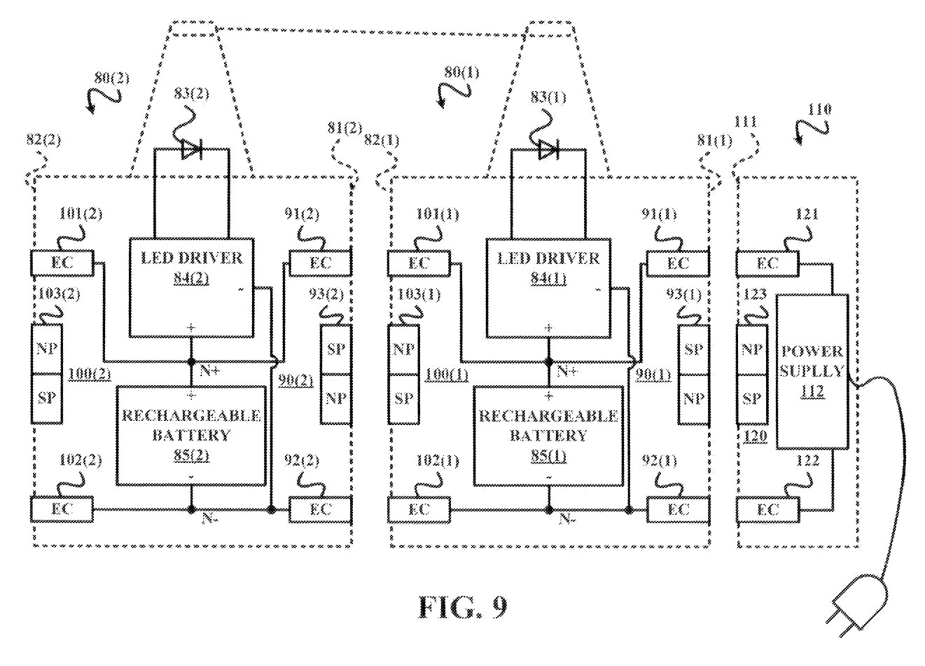

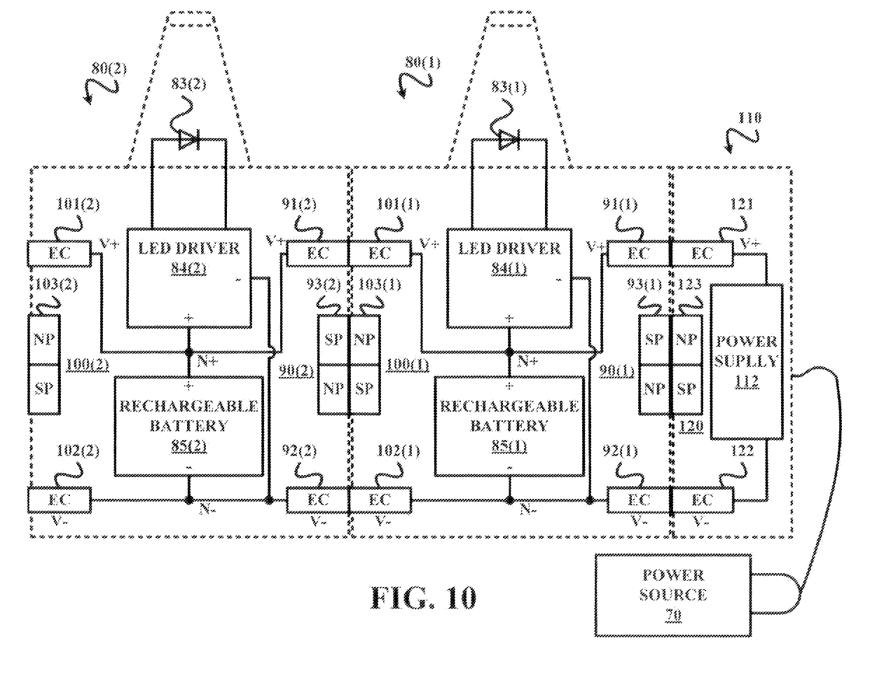

FIGS. 9 and 10 illustrate a schematic diagram of a second embodiment of a pair of rechargeable LED candle units and a second embodiment of a battery charger in accordance with the present invention.

The present invention is premised on providing a rechargeable electronic device of any type that employs a magnetic rechargee interface for recharging the rechargeable electronic device and a magnetic rechargor interface for simultaneously recharging one or more additional rechargeable electronic devices. Specifically, the magnetic rechargee interface is structurally constructed to be magnetically connected to a battery charger to thereby establish an electric connection between the rechargeable electronic device and the battery charger for purposes of recharging the rechargeable electronic device. The magnetic rechargee interface is further structurally constructed to be magnetically connected to a magnetic rechargor interface of another rechargeable electronic device magnetically coupled to the battery charger to thereby establish an electric connection between its rechargeable electronic device and the battery charger for purposes of simultaneously recharging the rechargeable electronic devices.

In one embodiment, each interface includes one or more magnetic electrical connectors of any type. In another embodiment, each interface includes one or more magnetic connectors of any type and one or more electrical connectors of any type.

To facilitate a further understanding of the magnetic rechargee interface and the magnetic rechargor interface of the present invention, the following is a description of a rechargeable LED candle unit employing the magnetic rechargee interface and the magnetic rechargor interface of the present invention. From this description, those having ordinary skill in the art will appreciate how to employ and use the magnetic rechargee interface and the magnetic rechargor interface of the present invention in other types of rechargeable electronic devices.

FIGS. 1-4 illustrates an exterior construction of a LED candle unit 20 having a magnetic rechargee interface 30 and a magnetic rechargor interface 40 of the present invention. Magnetic rechargee interface 30 includes a magnetic electrical connector 31 and a magnetic electrical connector 32 positioned behind LED candle unit 20 and adjacent a sidewall 21 of LED candle unit 20. Magnetic rechargor interface 40 includes a magnetic electrical connector 41 and a magnetic electrical connector 42 positioned within LED candle unit 20 and partially extending through a sidewall 22 of LED candle unit 20.

FIG. 5 illustrates three (3) LED candle units 20 aligned with a battery charger 50 of the present invention, which has a magnetic rechargor interface 60 including a magnetic electrical connector 61 and a magnetic electrical connector 62 positioned within battery charger 40 and partially extending through a sidewall 51 of battery charger 50. In a recharging operation as shown in FIG. 6, the magnetic rechargee interface of LED candle unit 20(1) (not shown) is magnetically connected to magnetic rechargor interface 60 of battery charger 50 as shown in FIG. 5, the magnetic rechargee interface of LED candle unit 20(2) (not shown in FIG. 5) is magnetically connected to magnetic rechargor interface 40(1) of LED candle unit 20(1) as shown in FIG. 5, and the magnetic rechargee interface of LED candle unit 20(3) (not shown in FIG. 5) is magnetically connected to magnetic rechargor interface 40(2) of LED candle unit 20(2) as shown in FIG. 5. As a result, battery charger 50 is simultaneously electrically connection to all three (3) LED candle units 20 whereby all three (3) LED candle unit 20 can be simultaneously recharged.

To further facilitate an understanding of the simultaneous recharging of LED candle units, FIG. 7 illustrates an exemplary internal electrical circuit construction of a pair of LED candle units 20 and an exemplary internal electrical circuit construction of battery charger 50.

As shown in FIG. 7, each LED candle unit 20 employs a rechargeable battery 25 powering a LED driver 24 for purposes of driving a LED 23. To this end, LED driver 24, rechargeable battery 25, magnetic electrical connector 31 and magnetic electrical connector 41 are electrically connected to a positive recharging node N+. In addition, LED driver 24, rechargeable battery 25, magnetic electrical connector 32 and magnetic electrical connector 42 are electrically connected to a negative recharging node N−.

Battery charger 50 employs a power supply 52 electrically connected to magnetic electrical connector 61 and magnetic electrical connector 62.

When sufficiently charged, each rechargeable battery 25 is capable of individually powering its associated LED driver 24 for purposes of driving its associated LED 23. When insufficiently recharged, each rechargeable battery 25 is capable of being simultaneously recharged based on a magnetic electrical daisy connection of both LED candle units 20 and battery charger 50 via the illustrated magnetic electrical connectors and based on an electrical connection of power supply 52 (e.g., a transformer based power supply) to a power source 70 (e.g., an AC wall outlet) as shown in FIG. 8. Specifically, the magnetic electrical daisy connection of both LED candle units 20 and battery charger 50 via the illustrated magnetic electrical connectors and the electrical connection of power supply 52 to power source 70 applies a positive recharging voltage V+ to each positive recharging node N+ and applies a negative recharging voltage V− to each negative recharging node N− for purposing of facilitating a simultaneous current flow into both LED driver 24 and rechargeable battery 25 of each LED candle unit 20.

Please note that the connotation of positive and negative to the recharging nodes N and the recharging voltages V for purposes of the present invention signifies each recharging voltage V can be either positive, negative or null as long as positive recharging voltage V+ as applied to positive recharging nodes N+ is greater than the negative recharging voltage V− as applied to negative recharging nodes N−, and the recharging voltages V are appropriate for recharging rechargeable batteries 25.

To ensure a proper recharging of LED candle units 20 as shown in FIG. 8, a south pole (“SP”) of magnetic electrical connector 31(1) is magnetically connected to a north pole (“NP”) of magnetic electrical connector 61, a south pole of magnetic electrical connector 31(2) is magnetically connected to a north pole of magnetic electrical connector 41(1), a north pole of magnetic electrical connector 32(1) is magnetically connected to a south pole of magnetic electrical connector 62, and a north pole of magnetic electrical connector 32(2) is magnetically connected to a south pole of magnetic electrical connector 42(1).

Alternatively, the same magnetic polarity for magnetic electrical connectors 31(1) and 32(1) (e.g., north pole polarity) can be magnetically connected to the opposite magnetic polarity for magnetic electrical connectors 61 and 62 (e.g., south pole polarity), and the same magnetic polarity for magnetic electrical connectors 31(2) and 32(2) (e.g., north pole polarity) can be magnetically connected to the opposite magnetic polarity for magnetic electrical connectors 41(1) and 41(2) (e.g., south pole polarity). For this alternative embodiment, additional circuitry (not shown) may be included to ensure a proper recharging of LED candle units 20.

To further facilitate an understanding of the simultaneous recharging of LED candle units, FIG. 9 illustrates an exemplary internal electrical circuit construction of a pair of LED candle units 80 and an exemplary internal electrical circuit construction of a battery charger 110.

In this embodiment, a magnetic rechargee interface 90(1) of LED candle unit 80(1) employs a pair of electrical connectors (“EC”) 91(1) and 92(1) and a magnet 93(1) positioned within LED candle unit 80(1) and adjacent a sidewall 81(1) of LED candle unit 80(1). a magnetic rechargor interface 100(1) of LED candle unit 80(1) employs a pair of electrical connectors 101(1) and 102(1) and a magnet 103(1) positioned within LED candle unit 80(1) and partially extending through a sidewall 82(1) of LED candle unit 80(1).

A magnetic rechargee interface 90(2) of LED candle unit 80(2) employs a pair of electrical connectors 91(2) and 92(2) and a magnet 93(2) positioned within LED candle unit 80(2) and adjacent a sidewall 81(2) LED candle unit 80(2). a magnetic rechargor interface 100(2) of LED candle unit 80(2) employs a pair of electrical connectors 101(2) and 102(2) and a magnet 103(2) positioned within LED candle unit 80(2) and partially extending through a sidewall 82(2) of LED candle unit 80(2).

A magnetic rechargee interface 120 of battery charger 110 employs a pair of electrical connectors 121 and 122 and a magnet 123 positioned within battery charger 110 and partially extending through a sidewall 111 of battery charger 110.

As shown in FIG. 9, each LED candle unit 80 employs a rechargeable battery 85 powering a LED driver 84 for purposes of driving a LED 83. To this end, LED driver 84, rechargeable battery 85, electrical connector 91 and electrical connector 101 of each LED candle unit 80 are electrically connected to a positive recharging node N+. In addition, LED driver 84, rechargeable battery 85, electromagnet connector 92 and electrical connector 102 of each LED candle unit 80 are electrically connected to a negative recharging node N−.

Battery charger 110 employs a power supply 112 electrically connected to electrical connector 61 and electrical connector 62.

When sufficiently charged, each rechargeable battery 85 is capable of individually powering its associated LED driver 84 for purposes of driving its associated LED 83. When insufficiently recharged, each rechargeable battery 85 is capable of being simultaneously recharged base on the magnetic electrical daisy connection of both LED candle units 80 and battery charger 110 via the illustrated electrical connectors and magnets and based on an electrical connection of power supply 112 (e.g., a transformer based power supply) to power source 70 (e.g., an AC wall outlet) as shown in FIG. 10. Specifically, the magnetic electrical connection of both LED candle units 80 and battery charger 110 via the illustrated electrical connectors and magnets and the electrical connection of power supply 112 to power source 70 applies a positive recharging voltage V+ to each positive recharging node N+ and applies a negative recharging voltage V− to each negative recharging node N− for purposing of facilitating a simultaneous current flow into both LED driver 84 and rechargeable battery 85 of each LED candle unit 80.

Again, please note that the connotation of positive and negative to the recharging nodes N and the recharging voltages V for purposes of the present invention signifies each recharging voltage V can be either positive, negative or null as long as positive recharging voltage V+ as applied to positive recharging nodes N+ is greater than the negative recharging voltage V− as applied to negative recharging nodes N−, and the recharging voltages V are appropriate for recharging rechargeable batteries 85.

To ensure a proper recharging of LED candle units 80 as shown in FIG. 10, a south pole (“SP”) of magnet 93(1) is magnetically connected to a north pole (“NP”) of magnet 113, a north pole of electric magnet 93(1) is magnetically connected to a south pole of magnet 113, a south pole of magnet 93(2) is magnetically connected to a north pole of magnet 103(2), a north pole of electric magnet 93(2) is magnetically connected to a south pole of magnet 103(2).

Alternatively, the same magnetic polarity for magnets 93(1) (e.g., north pole polarity) can be magnetically connected to the opposite magnetic polarity for magnet 123 (e.g., south pole polarity), and the same magnetic polarity for magnet 93(2) (e.g., north pole polarity) can be magnetically connected to the opposite magnetic polarity for magnet 103(1) (e.g., south pole polarity). For this alternative embodiment, additional circuitry (not shown) may be included to ensure a proper recharging of LED candle units 80.

Referring to FIGS. 1-10, those having ordinary skill in the art will appreciate numerous advantages of the present invention including, but not limited to, providing a technique for intuitively and easily connecting a number of rechargeable electronic devices of any type (e.g., LED candle light units) for purposes of simultaneously recharging the devices. Those having ordinary skill in the art will further appreciate various additional forms of a battery charger incorporating a magnetic rechargee interface of the present invention for purposes of simultaneously recharging multiple rechargeable electronic devices.

While the embodiments of the present invention disclosed herein are presently considered to be preferred, various changes and modifications can be made without departing from the spirit and scope of the present invention. The scope of the present invention is indicated in the appended claims, and all changes that come within the meaning and range of equivalents are intended to be embraced therein.

1. A rechargeable electronic device (20, 80), comprising:
a magnetic rechargee interface (30, 90); and
a magnetic rechargor interface (40, 100) in electrical communication with the magnetic rechargee interface (30, 90),
wherein the magnetic rechargee interface (30, 90) and the magnetic rechargor interface (40, 100) are operable to simultaneously recharge the rechargeable electronic device (20, 80) and at least one additional rechargeable electronic device (20, 80) based on the magnetic rechargee interface (30, 90) being magnetically coupled to a battery charger (50, 110) and based on the magnetic rechargor interface (40, 100) being magnetically coupled to the at least one additional rechargeable electronic device (20, 80).

2. The rechargeable electronic device (20, 80) of claim 1, further comprising:
a rechargeable battery (25) electrically connected to a positive recharging node (N+) and a negative recharging node (N−),
wherein the magnetic rechargee interface (30) includes a first magnetic electrical connector (31) electrically connected to the positive recharging node (N+), and
wherein the magnetic rechargee interface (30) further includes a second magnetic electrical connector (32) electrically connected to the negative recharging node (N−).

3. The rechargeable electronic device (20, 80) of claim 2,
wherein the magnetic rechargor interface (40) includes a third magnetic electrical connector (41) electrically connected to the positive recharging node (N+), and
wherein the magnetic rechargor interface (40) further includes a fourth magnetic electrical connector (42) electrically connected to the negative recharging node (N−).

4. The rechargeable electronic device (20, 80) of claim 1, further comprising:
a rechargeable battery (85) electrically connected to a positive recharging node (N+) and a negative recharging node (N−),
wherein the magnetic rechargee interface (90) includes a first electrical connector (91) electrically connected to the positive recharging node (N+),
wherein the magnetic rechargee interface (90) further includes a second electrical connector (92) electrically connected to the negative recharging node (N−).

5. The rechargeable electronic device (20, 80) of claim 4,
wherein the magnetic rechargee interface (90) further includes a magnet (93); and
wherein the first electrical connector (91) and the second electrical connector (92) are operationally dependent upon the magnet (93) being magnetically coupled to the battery charger (110).

6. The rechargeable electronic device (20, 80) of claim 4,
wherein the magnetic rechargor interface (100) includes a third electrical connector (101) electrically connected to the positive recharging node (N+), and
wherein the magnetic rechargor interface (100) further includes a fourth electrical connector (102) electrically connected to the negative recharging node (N−).

7. The rechargeable electronic device (20, 80) of claim 6,
wherein the magnetic rechargor interface (100) further includes a magnet (103); and
wherein the third electrical connector (101) and the fourth electrical connector (102) are operationally dependent upon the magnet (103) being magnetically coupled to the at least one additional rechargeable electronic device (20, 80).

8. A magnetic electrical daisy chain connection system, comprising:
a batter charger (50, 110); and
a rechargeable electronic device (20, 80) including
a magnetic rechargee interface (30, 90), and
a magnetic rechargor interface (40, 100) in electrical communication with the magnetic rechargee interface (30, 90),
wherein the magnetic rechargee interface (30, 90) and the magnetic rechargor interface (40, 100) are operable to simultaneously recharge the rechargeable electronic device (20, 80) and at least one additional rechargeable electronic device (20, 80) based on the magnetic rechargee interface (30, 90) being magnetically coupled to the battery charger (50, 110) and based on the magnetic rechargor interface (40, 100) being magnetically coupled to the at least one additional rechargeable electronic device (20, 80).

9. The magnetic daisy electrical chain connection system of claim 8,
wherein the rechargeable electronic device (20) further includes a rechargeable battery (25) electrically connected to a positive recharging node (N+) and a negative recharging node (N−),
wherein the magnetic rechargee interface (30) includes a first magnetic electrical connector (31) electrically connected to the positive recharging node (N+), and
wherein the magnetic rechargee interface (30) further includes a second magnetic electrical connector (32) electrically connected to the negative recharging node (N−).

10. The magnetic daisy electrical chain connection system of claim 9,
wherein the magnetic rechargor interface (40) includes a third magnetic electrical connector (41) electrically connected to the positive recharging node (N+), and
wherein the magnetic rechargor interface (40) further includes a fourth magnetic electrical connector (42) electrically connected to the negative recharging node (N−).

11. The magnetic daisy electrical chain connection system of claim 8,
wherein the rechargeable electronic device (80) further includes a rechargeable battery (85) electrically connected to a positive recharging node (N+) and a negative recharging node (N−),
wherein the magnetic rechargee interface (90) includes a first electrical connector (91) electrically connected to the positive recharging node (N+), and
wherein the magnetic rechargee interface (90) further includes a second electrical connector (92) electrically connected to the negative recharging node (N−).

12. The magnetic daisy electrical chain connection system of claim 11,
wherein the magnetic rechargee interface (90) further includes a magnet (93); and
wherein the first electrical connector (91) and the second electrical connector (92) are operationally dependent upon the magnet (93) being magnetically coupled to the battery charger (110).

13. The magnetic daisy electrical chain connection system of claim 11,
wherein the magnetic rechargor interface (100) includes a third electrical connector (101) electrically connected to the positive recharging node (N+), and
wherein the magnetic rechargor interface (100) further includes a fourth electrical connector (102) electrically connected to the negative recharging node (N−).

14. The magnetic daisy electrical chain connection system of claim 13,
wherein the magnetic rechargor interface (100) further includes a magnet (103); and
wherein the third electrical connector (101) and the fourth electrical connector (102) are operationally dependent upon the magnet (103) being magnetically coupled to the at least one additional rechargeable electronic device (20, 80).

15. A magnetic daisy electrical chain connection system, comprising:
a first rechargeable electronic device (20, 80) including
a first magnetic rechargee interface (30, 90), and
a magnetic rechargor interface (40, 100) in electrical communication with the first magnetic rechargee interface (30, 90); and
a second rechargeable electronic device (20, 80) including a second magnetic rechargee interface (30, 90),
wherein the first magnetic recharge interface (30, 90), the first magnetic rechargor interface (40, 100) and the second magnetic rechargee interface (30, 90) are operable to simultaneously recharge the first rechargeable electronic device (20, 80) and the second additional rechargeable electronic device (20, 80) based on the first magnetic rechargee interface (30, 90) being magnetically coupled to a battery charger (50, 110) and based on the magnetic rechargor interface (40, 100) being magnetically coupled to the second magnetic rechargee interface (30, 90).

16. The magnetic daisy electrical chain connection system of claim 15,
wherein the first rechargeable electronic device (20) further includes a rechargeable battery (25) electrically connected to a positive recharging node (N+) and a negative recharging node (N−),
wherein the first magnetic rechargee interface (30) includes a first magnetic electrical connector (31) electrically connected to the positive recharging node (N+), and
wherein the first magnetic rechargee interface (30) further includes a second magnetic electrical connector (32) electrically connected to the negative recharging node (N−).

17. The magnetic daisy electrical chain connection system of claim 16,
wherein the magnetic rechargor interface (40) includes a third magnetic electrical connector (41) electrically connected to the positive recharging node (N+), and
wherein the magnetic rechargor interface (40) further includes a fourth magnetic electrical connector (42) electrically connected to the negative recharging node (N−).

18. The magnetic daisy electrical chain connection system of claim 15,
wherein the first rechargeable electronic device (80) further includes a rechargeable battery (85) electrically connected to a positive recharging node (N+) and a negative recharging node (N−),
wherein the first magnetic rechargee interface (90) includes a first electrical connector (91) electrically connected to the positive recharging node (N+), and
wherein the first magnetic rechargee interface (90) further includes a second electrical connector (92) electrically connected to the negative recharging node (N−).

19. The magnetic daisy electrical chain connection system of claim 18,
wherein the first magnetic rechargee interface (90) further includes a magnet (93); and
wherein the first electrical connector (91) and the second electrical connector (92) are operationally dependent upon the magnet (93) being magnetically coupled to the battery charger (110).

20. The magnetic daisy electrical chain connection system of claim 18,
wherein the magnetic rechargor interface (100) includes a third electrical connector (101) electrically connected to the positive recharging node (N+), and
wherein the magnetic rechargor interface (100) further includes a fourth electrical connector (102) electrically connected to the negative recharging node (N−).

21. The magnetic daisy electrical chain connection system of claim 20,
wherein the magnetic rechargor interface (100) further includes a magnet (103); and
wherein the third electrical connector (101) and the fourth electrical connector (102) are operationally dependent upon the magnet (103) being magnetically coupled to the second rechargee interface (90) of the second rechargeable electronic device (80).
